(19) United States
(12) Patent Application Publication
(10) Pub. No.: US 2024/0430319 A1
(43) Pub. Date: Dec. 26, 2024

(54) DATA CHANNEL MANAGEMENT IN AN INTERACTIVE LIVE STREAMING NETWORK

(71) Applicant: Infrared5, Inc., Jamaica Plain, MA (US)

(72) Inventors: Christopher Allen, Boston, MA (US); Todd Anderson, Middlebury, VT (US); Paul Gregoire, JR., Henderson, NV (US); Andrew Shaules, Tacoma, WA (US); Mark Pace, Santa Cruz, CA (US)

(21) Appl. No.: 18/749,939

(22) Filed: Jun. 21, 2024

Related U.S. Application Data
(60) Provisional application No. 63/509,456, filed on Jun. 21, 2023.

(51) Int. Cl. H04L 65/65

(52) U.S. Cl. CPC H04L 65/65

(57) ABSTRACT

A computer system is provided in which one or more data channels can be established within the same connection as any streaming media channels using the same setup protocol. A data channel enabled protocol layer enables establishment of any number and types of channels, whether only one channel or multiple channels, of one or more kinds of data channels. An application using the data channel enabled protocol layer may choose to establish any number and type of channels. Integrating both streaming media and related data into multiple distinct channels within a single connection provides significant advantages over maintaining separate connections and supports multiple distinct use cases.

### CROSS-REFERENCE TO RELATED APPLICATIONS

This application is a non-provisional application claiming priority to, and the benefit of, prior filed U.S. Provisional Patent Application Ser. No. 63/509,456, filed Jun. 21, 2023, entitled “DATA CHANNEL MANAGEMENT IN AN INTERACTIVE LIVE STREAMING NETWORK”, which is hereby incorporated by reference.

### BACKGROUND

Interactive live streaming of video, audio, and related data, with a large number of participants presents some unique challenges that are not addressed by common broadcast-oriented streaming protocols.

For example, a commonly-used streaming protocol is the Web Real-Time Communication (WEBRTC) protocol, which was originally designed to facilitate data transfer between peer-to-peer connections. Using the WEBRTC protocol, there is a protocol for ingesting streaming data from a source device into a WEBRTC channel using the HyperText Transfer Protocol (HTTP). This protocol is called WebRTC-HTTP ingestion protocol (WHIP). There also is a protocol for egressing streaming data from a WEBRTC channel into a client device. This protocol is called WebRTC-HTTP Egress Protocol (WHEP). The WHIP and WHEP protocols do not support transmission of metadata, or other data related to the streamed media data, in a data channel within the WEBRTC protocol. Draft specifications of WHIP and WHIP protocols had suggested using either long polling over HTTP or the WebSocket Protocol to process “Server Sent Events.”

Current systems that support live interaction often separate management of video streaming from management of any messaging layer that carries related data. Management of data transmission over multiple protocols introduces complexity. For instance, a sports betting application may utilize the WebRTC protocol or the HTTP live streaming (HLS) protocol for video delivery while employing a separate WebSocket system for the transmission of betting data.

Another technique that has been used is to add metadata to the video stream using a technique called “insertable streams”. Using this technique, metadata is appended to video frames after the inclusion of a known keyword. A standard video player that does not include programming that processes this keyword ignores the data after the keyword. A customized video player, such as a web browser implementing the Insertable Streams feature, can read the metadata included after the video data and following the keyword. Using insertable streams, the metadata can include information in binary or encoded binary formats. Using insertable streams, metadata is stored with its corresponding video data in any recording. Also, metadata is inherently synchronized with the video by being included with the video data.

However, there are several drawbacks to using insertable streams. First, video must be playing for the metadata to update within the player. If video is paused or switched away, for example in favor of a different video, the metadata will cease to be delivered. Second, if used in a multiview scenario, the stream that carries the metadata must be processed by the player the whole time even if that stream is not the video being displayed. This processing can cause bandwidth consumption to be doubled, and for a variety of reasons, result in a bad user experience. Finally, insertable streams require use of a customized video player to extract the metadata from the video frames.

The management of persistent Transmission Control Protocol (TCP) connections to support using long polling over HTTP or the WebSocket protocol is known to be challenging, especially when attempting to scale. Each TCP connection involves a three-step handshake protocol to initiate the connection. Afterwards, additional messages are sent to ensure that the connection remains open. In contrast, the unigram data protocol (UDP), which underlies the WebRTC protocol, is connectionless.

### SUMMARY

This Summary introduces a selection of concepts in simplified form that are described further below in the Detailed Description. This Summary neither identifies key or essential features, nor limits the scope of the claimed subject matter.

A computer system is provided in which one or more data channels can be established within the same connection as any streaming media channels using the same setup protocol. A data channel enabled setup protocol layer enables establishment of any number and types of channels, whether only one channel or multiple channels, of one or more kinds of data channels, including but not limited to, only one data channel, only one or more data channels, only one audio channel, only one or more audio channels, only one video channel, only one or more video channels, or only data and audio channels, or only data and video channels, or only audio and video channels, or data, audio, and video channels. Whatever number and types of connections the data channel enabled WHIP/WHEP layer can establish, an application using the data channel enabled WHIP/WHEP layer may choose to establish fewer connections, and may request establishment of, as limited by the capabilities of the data channel enabled WHIP/WHEP layer, any number, whether only one channel or multiple channels, of one or more kinds of data channels, including but not limited to, only one data channel, only one or more data channels, only one audio channel, only one or more audio channels, only one video channel, only one or more video channels, or only data and audio channels, or only data and video channels, or only audio and video channels, or data, audio, and video channels.

Integrating both streaming media and related data into multiple distinct channels within a single connection provides significant advantages over maintaining separate connections and supports multiple distinct use cases. For example, there is reduced complexity by using only one communication protocol. Further, only one WebRTC connection is managed to transfer all related data. Moreover, using the WebRTC protocol, data on the data channel can be more easily synchronized with any related audio or video data. Additionally, each data channel transmits its data using a UDP session within the WebRTC connection, instead of using TCP connections. By setting up data channels using the WHIP/WHEP protocols and by transmitting data over a WebRTC connection, significant performance and scaling advantages are provided compared to use of other techniques for transmission of data related to streaming media. By using WebRTC, the benefits of User Datagram Protocol (UDP) sessions between each node in a cluster are leveraged to reduce the load associated with otherwise managing multiple persistent Transmission Control Protocol (TCP) connections. The stateless UDP sessions used in WebRTC offer reduced overhead and improved performance and scaling compared to TCP-based solutions.

With bidirectional data channels associated with audio or video, or both, which are being communicated among multiple publishers and subscribers, including one-to-many, many-to-one, and many-to-many forms of communication, a wide variety of live, interactive applications can be supported along with live real time media transmission. Further, there are benefits to using a WebRTC connection for data channels only, without audio or video, or with data and audio only. A WebRTC connection can be established with only one, or more than one, data channel without any audio or video channel. Because the data channel is bidirectional, low latency, and real-time, it allows a variety of communication applications which exchange data, such as text-based chat, betting data for sports microbetting applications, telemetry data from vehicles or aircraft, and yet other applications. These use cases demonstrate the versatility and usefulness of the sole or added data channel support.

Accordingly, in one aspect, a computer system includes a processing system including one or more processing devices and one or more computer storage devices, the processing system processing computer program instructions that configure the processing system. The configured processing system includes an application processing data, a setup protocol client, and a real-time streaming client. The setup protocol client is in communication with the application and is responsive to the application to request establishment of a real-time streaming connection using a real-time streaming protocol with another device. The request includes a request for one or more bidirectional data channels within the real-time streaming connection. The real-time streaming client is in communication with the application to receive the data from the application and to communicate the data to the other device over the bidirectional data channel of the real-time streaming connection.

In one aspect, a computer-implemented process involves an application sending a request to a setup protocol client including a request for one or more bidirectional data channels within a real-time streaming connection using a real-time streaming protocol with another device. The setup protocol client, responsive to the request from the application, establishes the real-time streaming connection with the requested one or more bidirectional channels with the other device. The application initiates sending of data on the requested one or more bidirectional channels to the other device through a real-time streaming client. The real-time streaming client receives data from the application and communicates data to the other device over the bidirectional data channel of the real-time streaming connection.

In one aspect, a computer system includes a means for receiving a request from an application for one or more bidirectional data channels within a real-time streaming connection using a real-time streaming protocol with another device. The computer system further includes means, responsive to the request from the application, for establishing the real-time streaming connection with the requested one or more bidirectional channels with the other device. The computer system further includes means for receiving data from the application for communicating the data to the other device over the bidirectional data channel of the real-time streaming connection.

In one aspect, a computer program product includes a computer storage device storing computer program instructions that, when processed by a processing unit, configures the processing unit to include a setup protocol client. The setup protocol client is responsive to a request from an application to establish a real-time streaming connection using a real-time streaming protocol with another device. The request includes a request for one or more bidirectional data channels within the real-time streaming connection.

In one aspect, a computer system includes a processing system including one or more processing devices and one or more computer storage devices, the processing system processing computer program instructions that configure the processing system. The configured processing system includes an application processing data, a setup protocol client, and a real-time streaming client. The setup protocol client is in communication with the application and is responsive to the application to request establishment of a real-time streaming connection using a real-time streaming protocol with another device. The request includes a request for one or more bidirectional data channels within the real-time streaming connection. The real-time streaming client is in communication with the other device to receive data over the bidirectional data channel of the real-time streaming connection and to communicate the received data to the application.

In one aspect, a computer-implemented process involves an application sending a request to a setup protocol client including a request for one or more bidirectional data channels within a real-time streaming connection using a real-time streaming protocol with another device. The setup protocol client, responsive to the request from the application, establishes the real-time streaming connection with the requested one or more bidirectional channels with the other device. The real-time streaming client receives data from the other device over the bidirectional data channel of the real-time streaming connection. The real-time streaming application provides the received data to the application.

In one aspect, a computer system includes a means for receiving a request from an application for one or more bidirectional data channels within a real-time streaming connection using a real-time streaming protocol with another device. The computer system further includes means, responsive to the request from the application, for establishing the real-time streaming connection with the requested one or more bidirectional channels with the other device. The computer system further includes means for receiving data from the other device over the bidirectional data channel of the real-time streaming connection and means for communicating the received data to the application.

In one aspect, a computer system includes a processing system including one or more processing devices and one or more computer storage devices, the processing system processing computer program instructions that configure the processing system. The processing system is configured to implement a real-time streaming server instance and a setup protocol server instance. The real-time streaming server instance supports the establishment of a real-time streaming connection with one or more bidirectional data channels, to communicate data over the one or more bidirectional data channels of the real-time streaming connection. The setup protocol server instance is responsive to requests from other devices to establish a real-time streaming connection with the real-time streaming server instance. Such requests include a request for one or more bidirectional data channels within a requested real-time streaming connection. The setup protocol server instance, in response to a request from a device, issues a request to the real-time streaming server instance to establish the requested real-time streaming connection with the requested one or more bidirectional data channels. The setup protocol server instance responds to the device with connection information for the device to complete the requested real-time streaming connection.

In one aspect, a computer-implemented process includes a setup protocol server instance receiving a request from a device to establish a real-time streaming connection with a real-time streaming server instance. Such a request includes a request for one or more bidirectional data channels within a requested real-time streaming connection. In response to the request, the setup protocol server instance communicates with the real-time streaming server instance to establish the real-time streaming connection with the requested bidirectional data channel. The setup protocol server instance responds to the device with connection information for the device to complete the requested real-time streaming connection.

In one aspect, a computer system includes means for receiving a request from a device to establish a real-time streaming connection with a real-time streaming server instance. Such a request includes a request for one or more bidirectional data channels within a requested real-time streaming connection. The computer system includes means, responsive to the request, for communicating with the real-time streaming server instance to establish the real-time streaming connection with the requested bidirectional data channel. The computer system includes means, responsive to establishment of the real-time streaming connection, for communicating connection information to the device for the device to complete the requested real-time streaming connection.

In one aspect, a computer program product includes a computer storage device storing computer program instructions that, when processed by a processing unit, configures the processing unit to include a setup protocol server instance. The setup protocol server instance is responsive to a request from a client device to establish a real-time streaming connection using a real-time streaming protocol with a real-time streaming server instance using a real-time streaming protocol. The request includes a request for one or more bidirectional data channels within the real-time streaming connection. The setup protocol server instance is responsive to the request to communicate with the real-time streaming server instance to establish the real-time streaming connection with the requested bidirectional data channel. The setup protocol server instance is responsive to establishment of the real-time streaming connection to communicate connection information to the device for the device to complete the requested real-time streaming connection.

In one aspect, a cluster of server computers comprises one or more origin servers and one or more edge servers, wherein each origin server is configured to receive streaming data from one or more publisher devices and wherein each edge server is configured to transmit streaming to one or more subscriber devices, wherein each origin server is configured with a respective real-time streaming protocol server instance implementing a real-time streaming protocol, and each edge server is configured with a respective real-time streaming server instance implementing the real-time streaming protocol, and wherein the cluster of server computers includes at least one setup protocol server instance responsive to requests from a publisher device or a subscriber device to establish a real-time streaming connection using the real-time streaming protocol with one of the real-time streaming server instances in the cluster of server computers, wherein the request includes a request for one or more bidirectional data channels within the real-time streaming connection, and wherein the setup protocol server instance is responsive to the request to communicate with one of the real-time streaming server instances to establish the real-time streaming connection with the requested bidirectional data channel, and wherein the setup protocol server instance is responsive to establishment of the real-time streaming connection to communicate connection information to the publisher device or subscriber device for the publisher device or subscriber device to complete the requested real-time streaming connection.

In any of the foregoing, in some implementations, the application sends data to the other device over the data channel. In some implementations, the application receives data from the other device over the data channel. In some implementations, the application both sends and receives data from the other device over the data channel.

In any of the foregoing, in some implementations, the application further processes streaming media data with the data, and wherein the setup protocol client is further responsive to the application to request establishment of one or more streaming media channels on the real-time streaming connection, and wherein the real-time streaming client is further in communication with the application to further receive the streaming media data and the data from the application and transmit the streaming media data over the one or more streaming media channels of the real-time streaming connection while communicating the data to and from the application over the bidirectional data channel of the real-time streaming connection. In some implementations, the data on the bidirectional data channel includes metadata to be synchronized with the live real-time streaming media data.

In any of the foregoing, in some implementations, the setup protocol client comprises a WebRTC for HTTP Ingest Protocol (WHIP) client and the real-time streaming client comprises a WebRTC client supporting the WebRTC protocol. In some implementations, the setup protocol client comprises a WebRTC for HTTP Ingest Protocol (WHEP) client and the real-time streaming client comprises a WebRTC client supporting the WebRTC protocol. In some implementations, the computer system comprises a WebRTC streaming server housing a WebRTC server instance and a WHIP/WHEP server instance. A WebRTC server instance also may be referred to as a media server in a WebRTC implementation.

In any of the foregoing, in some implementations, the computer system comprises a stream manager for a plurality of server computers comprising a plurality of WebRTC server computers, each WebRTC server computer including a respective WebRTC server instance. The stream manager includes a WHIP/WHEP server instance. The stream manager is configured to, in response to a request, select a WebRTC server computer for supplying the requested WebRTC connection and to communicate with the WebRTC server instance of the selected WebRTC server computer. The WHIP/WHEP server instance of the stream manager responds to the device requesting the WebRTC channels.

In any of the foregoing, in some implementations, the computer system comprises a load balancer for a plurality of server computers comprising a plurality of WebRTC server computers, each WebRTC server computer including a respective WebRTC server instance and an associated WHIP/WHEP server instance. The load balancer, in response to a request, selects a WebRTC server computer for supplying the requested WebRTC connection and communicates with the WHIP/WHEP server instance of the selected WebRTC server computer. The WHIP/WHEP server instance of the selected WebRTC server computer responds to the device requesting the WebRTC channels.

In one aspect, a computer system can be configured to establish a data channel, configure transmission parameters, and facilitate simultaneous data transfer in multiple directions between connected participants when users are connected to a single server or when users are connected across a cluster.

Any of the foregoing can include one or more of the following features. The application provides data in the format for a real time streaming protocol. The application converts the data in the format for the real time streaming protocol into metadata for transmission on the bidirectional data channel. The application converts the metadata received from the bidirectional data channel into data in the format for the real time streaming protocol. The data sent over the bidirectional data channel is compressed or encrypted. Compressed or encrypted data received over the bidirectional data channel is decompressed or decrypted.

Any of the foregoing can include one or more of the following features. The data on the bidirectional data channel includes metadata to be synchronized with the live real-time streaming media data. The metadata includes metadata time stamps corresponding to media data time stamps for the live real-time streaming media data and the system further ensures accurate and timely delivery of the metadata using the time stamps. Received metadata is buffered. Metadata includes data related to an event.

Any of the foregoing can include one or more of the following features. The data transmitted over the bidirectional data channel comprises Society of Cable Telecommunications Engineers (SCTE) 35 data. The data transmitted over the bidirectional data channel comprises binary data. The data transmitted on the bidirectional data channel includes one or more of the following data types: Key-Length-Value (KLV), JavaScript Object Notation (JSON), Remote Procedure Call (RPC).

Any of the foregoing can include one or more of the following features. The data transmitted on the bidirectional data channel includes statistics related to available bandwidth. A recipient of the live real-time streaming media sends the statistics to a transmitter of the live real-time streaming media. The transmitter is configured to adjust a characteristic of a transmitted stream based on the statistics. The transmitter uses a trained computational model to automatically adjust the cluster and stream settings in real-time. The statistics include information received based on utilizing Receiver Estimated Maximum Bitrate (REMB) or other Real-time Transport Control Protocol (RTCP) messages to adjust the optimal stream without exceeding available bandwidth. Adaptive bit rate is achieved using one or more transcoders. The statistics are indicative of available bandwidth. The system is further configured to estimate bandwidth based on the statistics. The system is further configured to allocate network resources based on the statistics.

Any of the foregoing can include one or more of the following features. The data transmitted on the data channel includes shared objects delivered over the data channel to enable efficient and seamless data sharing between participants. The application comprises one or more of a chat application, a whiteboard application, or a collaborative application. The application implements video conferencing. The data transmitted over the bidirectional data channel includes Digital Rights Management (DRM) metadata associated with media data transmitted on the one or more media data channels.

Any of the foregoing can include one or more of the following features. The data transmitted on the bidirectional data channel includes Remote Procedure Call (RPC) data. The RPC data includes a request message indicating an operation to be performed. The RPC data includes a response message indicating an output resulting from the operation to be performed. The RPC data includes a browser, thereby enabling RPC execution across browsers via the data channel.

Any of the foregoing can include one or more of the following features. The data transmitted over the data channel includes data and state information of nodes within a distributed computer system. The system maintains synchronization between nodes in a cluster through data channel-based messaging of data and state information.

Any of the foregoing can further include an error correction module that processes data received over the data channel.

Any of the foregoing aspects may be embodied as a computer system, as any individual component of such a computer system, as a process performed by such a computer system or any individual component of such a computer system, or as an article of manufacture including computer storage in which computer program code is stored and which, when processed by the processing system(s) of one or more computers, configures the processing system(s) of the one or more computers to provide such a computer system or individual component of such a computer system.

The following Detailed Description references the accompanying drawings which are part of this application and which show, by way of illustration, specific example implementations. Other implementations may be made without departing from the scope of the disclosure.

### BRIEF DESCRIPTION OF THE DRAWINGS

FIG. 1A is a schematic illustration of a software stack using conventional WHIP/WHEP protocols for only audio and video channels, and the WebSocket protocol for other data.

FIG. 1B is a schematic illustration of a software stack using techniques described herein to use WHIP or WHEP protocols to support data channels within a WebRTC connection.

FIG. 1C is a block diagram of the interaction of a client such as in FIG. 1B with a server computer supporting WebRTC and WHIP or WHEP protocols.

FIG. 2 is a sequence diagram describing how a data channel is integrated into an example system.

FIG. 3 is a sequence diagram describing an example session with a single server.

FIGS. 4A and 4B are a sequence diagram describing an example session with a cluster of servers using a signaling server.

FIGS. 5A and 5B are a sequence diagram describing a first example session with a load balanced cluster.

FIGS. 5C and 5D are a sequence diagram describing a second example session with a load balanced cluster.

FIG. 6 is a sequence diagram describing an example session using a data channel without streaming media.

FIG. 7 is a block diagram illustrating how such a system can be used to support adaptive bitrate applications, such as communicating data used in bandwidth calculations.

FIG. 8 is a block diagram illustrating how such a system can be used for advertisement insertion.

FIG. 9 is a block diagram illustrating how such a system can be used for chat.

FIG. 10 is a block diagram illustrating how such a system can be used for file transfer.

FIG. 11 is a block diagram illustrating how such a system can be used for screen sharing control.

FIG. 12 is a block diagram illustrating how such a system can be used for communicating metadata related to live events to client devices, such as sports events.

FIG. 13 is a block diagram illustrating how such a system can be used for communicating actions from client devices related to live events, such as sports betting.

FIG. 14 is a block diagram describing how such a system propagates data channel messages.

FIGS. 15A and 15B are a sequence diagram describing a session using a data channel to communicate digital rights management (DRM) information.

FIG. 16 is a block diagram of an example general-purpose computer.

### DETAILED DESCRIPTION

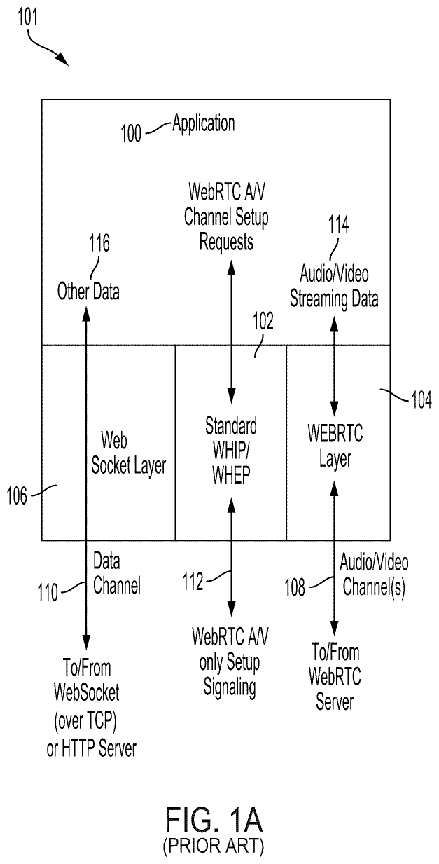

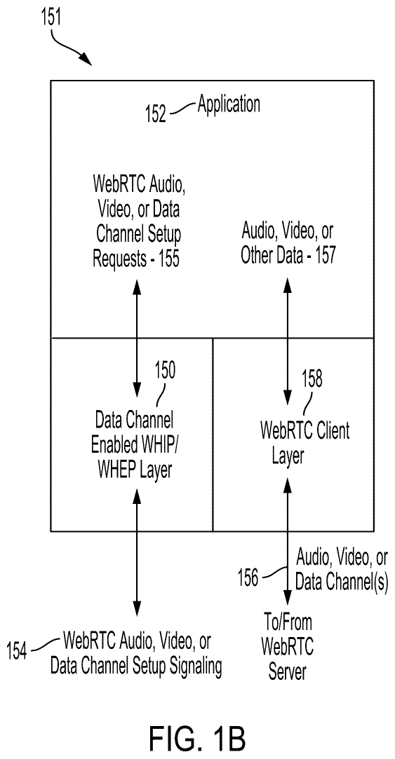

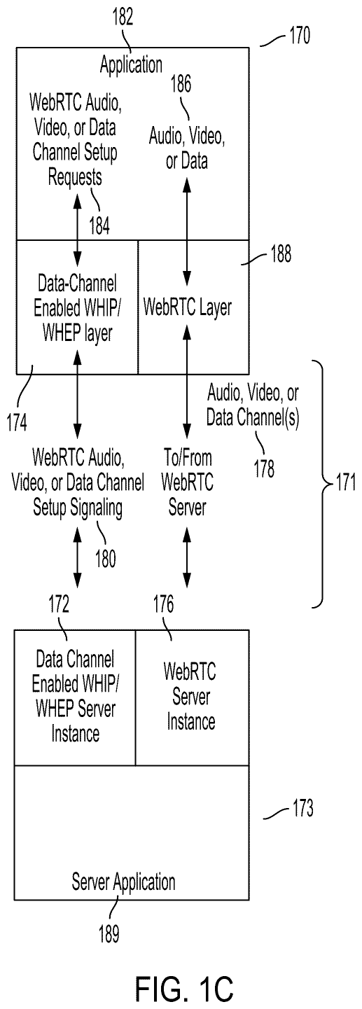

FIG. 1A is a schematic illustration of a software stack using conventional WHIP/WHEP protocols and the WebSocket protocol. In FIG. 1A, an application 100 running on a client computer 101 is used to communicate with another application on another computer (not shown), with a combination of streaming media data and related metadata. The client computer also has instances of a WHIP/WHEP client layer 102, a WEBRTC client layer 104, and a WebSocket client layer 106 running on the client computer. The application 100 establishes two communication connections to communicate with the other computer. Using the WHIP or WHEP protocol for signaling (as indicated at 112) to a WebRTC server (not shown), the application 100 configures the WebRTC layer 104 for communication of any audio or video streaming data 114 over audio and video channels 108 over a WebRTC connection to and from the WebRTC server. To communicate any other data 116, the application 100 configures the WebSocket layer 106 to set up a data channel 110 over a TCP connection for transmitting that other data. Alternatively, long polling over an HTTP connection could be used to transmit the other data 116.

Conventional implementation of the WHIP and WHEP protocols is described in at least a document entitled “WebRTC-HTTP ingestion protocol (WHIP)”, by S. Murillo and A. Gouaillard, published 19 Oct. 2022, and a document entitled “WebRTC-HTTP Egress Protocol (WHEP)”, by S. Murillo and C. Chen, published 29 Mar. 2023, which are hereby incorporated by reference, and which are accessible using the following URL with the HTTPS protocol (“https://”, and domain “datatracker.ietf.org/”:
doc/draft-ictf-wish-whip/05/
doc/draft-murillo-whep/02/
doc/draft-ictf-wish-whep/01/

As used herein, a “data channel enabled WHIP/WHEP” component, instance, or layer indicates a software component that implements the WHIP protocol, or the WHEP protocol, or both, as modified as described herein to support establishing one or more data channels over a WebRTC connection. Which implementation is being referred to should be apparent from the context. Client machines that transmit data using the WebRTC protocol, herein also called publisher devices, set up channels using a data channel enabled WHIP protocol and communicate with a corresponding data channel enabled WHIP instance on a server computer. Client machines that receive data using the WebRTC protocol, herein also called subscriber devices, set up channels using the data channel enabled WHEP protocol and communicate with a corresponding data channel enabled WHEP instance on a server computer.

FIG. 1B is a schematic illustration of a software stack on a client computer 151 using data channel enabled setup protocol, such as a modified WHIP/WHEP protocol. The WebRTC protocol implemented by a WebRTC client layer 158 supports establishing one or more bidirectional real-time data channels to communicate data, one or more real-time audio data channels, or one or more video data channels, or any combination of these. In the system of FIG. 1B, a data channel enabled WHIP/WHEP client layer 150 allows the application 152 on client computer 151 to configure one or more data channels for bidirectional communication of data over a WebRTC connection 156.

The data channel enabled WHIP/WHEP client layer 150 is invoked by the application 152, using requests 155, to perform signaling (as indicated at 154) with another computer (not shown) to establish one or more audio channels, or one or more video channels, or one or more data channels, or any combination of these, over a WebRTC connection 156. The data channel enabled WHIP/WHEP client layer 150 includes code that is responsive to the requests 155 from the application 152 to configure audio and video channels within a WebRTC connection 156, similar to the WHIP/WHEP client layer 102 (FIG. 1A). In addition, the data channel enabled WHIP/WHEP client layer 150 further includes code that is responsive to requests 155 from the application 152 to configure one or more data channels within the WebRTC connection 156. Similar modifications are made to a WHIP/WHEP instance on the WebRTC Server to be responsive to data channel setup signaling. Thus, using the data channel enabled WHIP or WHEP protocol, the application 152 configures the WebRTC client layer 158 for communication of any audio or video streaming data and any other data (as indicated at 157) over audio, video, and data channels over a single WebRTC connection 156 to and from the WebRTC server.

A data channel enabled WHIP/WHEP layer 150 can be programmed to enable establishment of any number, whether only one channel or multiple channels, of one or more kinds of data channels, including but not limited to, only one data channel, only one or more data channels, only one audio channel, only one or more audio channels, only one video channel, only one or more video channels, or only data and audio channels, or only data and video channels, or only audio and video channels, or data, audio, and video channels. Whatever number and types of connections the data channel enabled WHIP/WHEP layer can establish, an application using the data channel enabled WHIP/WHEP layer may choose to establish fewer connections, and may request establishment of, as limited by the capabilities of the data channel enabled WHIP/WHEP layer, any number, whether only one channel or multiple channels, of one or more kinds of data channels, including but not limited to, only one data channel, only one or more data channels, only one audio channel, only one or more audio channels, only one video channel, only one or more video channels, or only data and audio channels, or only data and video channels, or only audio and video channels, or data, audio, and video channels.

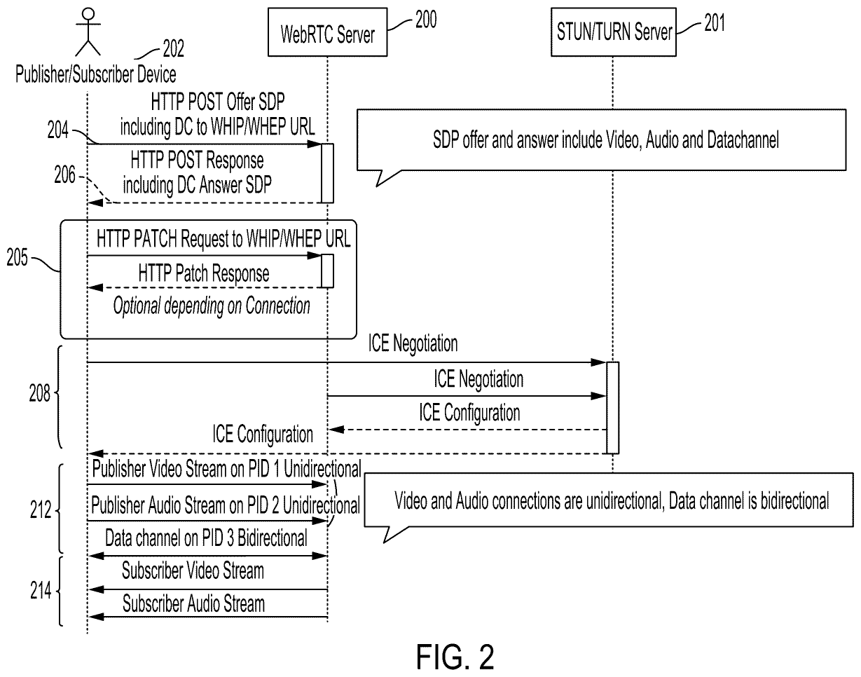

FIG. 1C is a block diagram describing the connection of a data channel enabled WHIP/WHEP layer 174 on client computer 170 over a computer network 171 with a corresponding data channel enabled WHIP/WHEP server instance 172 on a server computer 173 to set up WebRTC channels 178. The interaction to set up the channels is explained in more detail below in connection with FIGS. 2 through 6 and 15A-15B. In FIG. 1C, an application 182 issues requests 184 to a data channel enabled WHIP/WHEP layer 174 to set up one or more channels. The data channel enabled WHIP/WHEP client layer 174 communicates with the data channel enabled WHIP/WHEP server instance 172 on the server computer 173 using signaling 180. The data channel enabled WHIP/WHEP server instance 172 coordinates with the WebRTC server instance 176, often called a media server, to set up the requested channel(s), whether a data channel, an audio channel, a video channel, or any combination of one or more of such channels, within a WebRTC connection. While FIG. 1C illustrates the WebRTC server instance 176 and WHIP/WHEP server instance 172 on the same server computer 173, the signaling server component (WHIP/WHEP) and the media server component (WebRTC) can be on separate machines or separate server computers. The data channel enabled WHIP/WHEP server instance 172 returns information about the WebRTC connection and the WebRTC channel(s) to the client application 182 through the data channel enabled WHIP/WHIP client layer 174 using signaling 180. The application 182 can then start using the WebRTC layer 188 to communicate audio data, video data, or other data, or any combination of these (as indicated at 186), over the requested channel(s) 178 on the WebRTC connection, to and/or from a server application 189.

By integrating a data channel with any audio or video data channels on the same WebRTC connection, numerous advantages are obtained. For example, there is reduced complexity by using only one communication protocol. Further, only one WebRTC connection is managed to transfer all related data. Moreover, data on the data channel can be more easily synchronized with any related audio or video data. Additionally, each data channel transmits its data using a UDP session within the WebRTC connection, instead of using TCP connections. Also, with bidirectional data channels associated with audio or video, or both, which are being communicated among multiple publishers and subscribers, including one-to-many, many-to-one, and many-to-many forms of communication, a wide variety of live, interactive applications can be supported along with live real time media transmission.

While the example implementation described herein is based on the WHIP/WHEP protocol and the WebRTC protocol, the invention is not limited to such technologies. Any real-time streaming protocol that supports real-time streaming of data from one device to another over a real-time streaming network connection can be used. The devices can be connected in a point-to-point relationship or within a cluster of multiple computers, examples of which are described herein. The real-time streaming connection includes one or more bidirectional data channels, one or more streaming audio channels, or one or more streaming video channels or any combination of these. Such protocols typically are implemented using a real-time streaming client and a real-time streaming server instance. With such a real-time streaming protocol, a setup protocol client and setup protocol server instance initially communicate in response to requests from an application to handle signaling responsible for establishing a real-time streaming connection and one or more channels within that connection. Given an established real-time streaming connection with one or more bidirectional data channels, a wide variety of applications can be supported.

Given a data channel enabled WHIP/WHEP layer as in FIGS. 1B and 1C, a variety of interesting applications can be implemented which provide live, real-time, interactive communication among multiple producers and consumers of data in a system. For example, a live streaming system can use the WHIP and WHEP protocols to set up channels for live streaming media, such as video or audio or both, and related data from a source device to a client device using the WebRTC protocol. Such live streaming can be implemented in a cluster architecture which supports a large number of clients while providing a live video streaming experience with an end-to-end latency below 500 milliseconds (ms). The cluster architecture, in some embodiments, can be implemented on a cloud-based infrastructure (such as a set of servers provided by a service such as Amazon Web Services (AWS), Microsoft Azure, or any other cloud provider) using a set of compute instances that include Stream Managers devices, origin devices, relay devices, and edge devices that are deployed on the cloud infrastructure. The cluster architecture can be implemented using technologies other than a cloud-based cluster. A decentralized network such as described in the patent applications noted below, or other collection of server computers accessible over a computer network, can be used. In the example of a cloud infrastructure, for example, such a deployment can be controlled by the content providers or can be provided as a service to content providers. In some implementations, the cluster architecture includes a set of clusters that are deployed in different geographic regions to serve traffic coming from anywhere while providing low latency delivery of the video streams. Example implementations of such a cluster architecture are described in U.S. Pat. Nos. 8,019,878, 8,024,469, 8,171,145, 8,166,181, 8,019,867, 11,425,113, 11,438,638, and 11,778,011, and U.S. Published Patent Applications 2019/0320004, 2019/0320014, 2019/0028465, 2022/0094729, and 2022/0321945, all of which are hereby incorporated by reference.

Implementations of such a live streaming system can include one or more subscriber devices and one or more publisher devices. In some implementations, a Stream Manager is used to manage resources used to transfer streams of data. In some implementations, a load balancer is used to manage resources used to transfer streams of data. The following flowcharts describe implementations of the setup procedure, as implemented in a data channel enabled WHIP/WHEP layer, to configure such a live streaming system.

FIG. 2 is a sequence diagram describing the operation of data-channel-enabled WHIP/WHEP client and server instances as integrated into a system. In FIG. 2, there is a single server 200 which includes a server computer configured with a data channel enabled WHIP/WHEP server instance and a media server, such as a WebRTC server. The data channel enabled WHIP/WHEP server instance has a published URL that other devices can post messages to, such as using HTTP POST commands or other HTTP commands. A publisher device or subscriber device 202 also has a data-channel-enabled WHIP/WHEP client layer.

An application on publisher or subscriber device 202 invokes a call to the data channel enabled WHIP/WHEP client layer on the publisher or subscriber device 202, indicating the kinds of channels the application will be using. The data channel enabled WHIP/WHEP layer of the publisher or subscriber device sends (204) an HTTP Post message to a URL for the data channel enabled WHIP/WHEP instance on the server 200. This message includes an offer with a session description in the Session Description Protocol (SDP) format. The data channel enabled WHIP/WHEP instance of the server 200 interacts with the media server instance on the server 200 to set up the WebRTC connection with the requested data, audio, and video channels, and receives information about that connection back. The WHIP/WHEP server instance returns (206) the answer in SDP format in the POST response to the data channel enabled WHIP/WHEP client layer. This message includes an answer in the SDP format which includes information about the WebRTC connection. In this implementation, details specifying any requested data channels are included in the offer and the answer. The response also includes information about Interactive Connectivity Establishment (ICE) candidates for the WebRTC connection. In some implementations, the publisher device or subscriber device may transmit (205) an HTTP Patch Request to the URL for the data channel enabled WHIP/WHEP server instance and receive an HTTP Patch response.

Using the provided ICE candidates, the publisher or subscriber device follows conventional steps, as indicated at 208, of completing the WebRTC connection by attempting to establish a connection with ICE, helping this connection traverse Network Address Translation through a STUN (Session Traversal Utilities for NAT) and/or TURN (Traversal Using Relays around NAT) server 201. After establishing a connection, the publisher can transmit audio and video data unidirectionally, but the data channels support bidirectional communication.

Prior to the availability of systems implementing the WHIP/WHEP protocol, these steps to establish a WebRTC connection for audio and video data would have required several messages back and forth, adding latency to the connection establishment.

In the example of FIG. 2, after establishment of the data channels on a WebRTC connection with the media server, the publisher device 202 can transmit (212) or the subscriber device 202 can receive (214) audio or video streams over any established audio or video channels. Also, both kinds of devices can send and receive other data over any established bi-directional data channel.

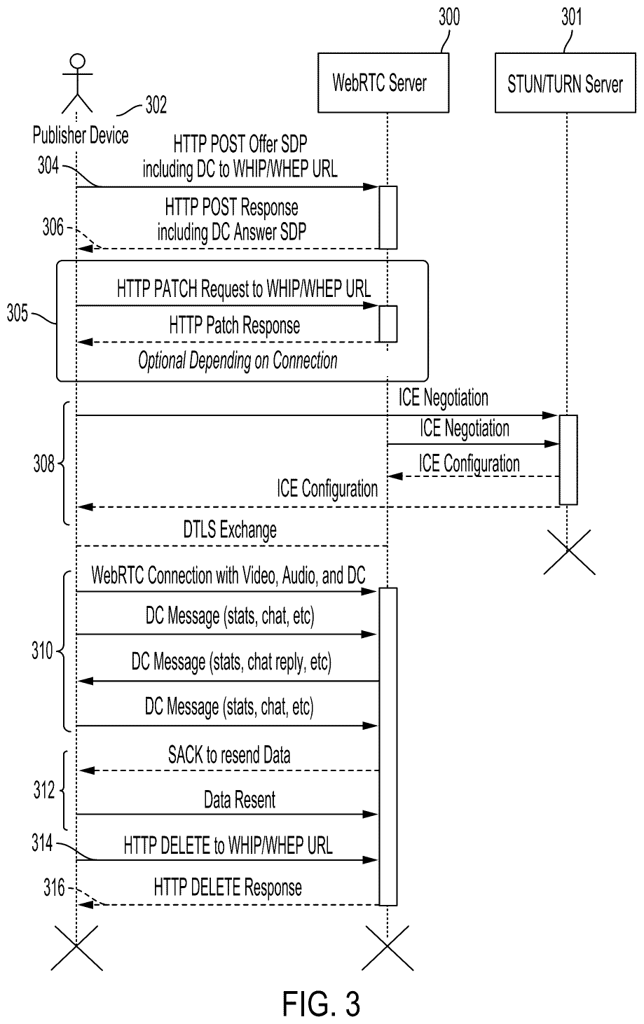

FIGS. 3 through 6 are sequence diagrams that describe how communication sessions with different kinds of servers incorporate the WebRTC connection setup using the techniques described in FIG. 2.

FIG. 3 is a sequence diagram describing a session between a publisher device 302 and a single WebRTC server 300. This sequence diagram illustrates the end-to-end process of establishing a data channel connection, sending and receiving data over the channel, and closing the connection in both WHIP and WHEP protocols.

An application on the publisher device 302 invokes a call to the data channel enabled WHIP/WHEP client layer, indicating the kinds of channels the application will be using. The data channel enabled WHIP/WHEP client layer sends (304) an HTTP Post message to a URL for the data channel enabled WHIP/WHEP server instance on the WebRTC server 300. This message includes an offer with a session description in the SDP format indicating a data channel (DC) and any other channels to be created. The data channel enabled WHIP/WHEP server instance interacts with the WebRTC server instance on the WebRTC server 300 to set up the WebRTC connection with the requested data channel, and any audio and video channels, and receives information about the channels and WebRTC connection back. The WHIP/WHEP server instance returns (306) the answer in SDP format in the POST response to the data channel enabled WHIP/WHEP client layer. This message includes an answer in the SDP format which includes information about the data channel (DC) and other channels and the WebRTC connection. In this implementation, details specifying any requested data channels are included in the offer and the answer. In some implementations, the publisher device may communicate (305) HTTP Patch requests and responses with the data channel enabled WHIP/WHEP server instance.

The response received at 306 also includes information about Interactive Connectivity Establishment (ICE) candidates for the WebRTC connection. Using the provided ICE candidates, publisher device 302 follows conventional steps, as indicated at 308, of completing the WebRTC connection by initiating ICE negotiation and configuration with the STUN/TURN server 301 and WebRTC server 300. In the example of FIG. 3, after establishment of the data channels on the WebRTC connection, the publisher device 302 can use the Datagram Transport Layer Security (DTLS) exchange of the WebRTC protocol to transmit and receive (310) any data over data channels and transmit any audio or video streams over audio or video channels. For example, the data channel can be used by the publisher device for transmitting statistics, other information, and chat messages, and receiving statistics, other information, and chat replies. In some implementations, data may not be received by the WebRTC server 300, and an “SACK” message is sent by the WebRTC server 300 to the WebRTC layer on the publisher device 302, which in response resends data, as indicated at 312.

When the applications on the publisher device 302 and WebRTC server 300 cease communicating, the publisher device sends 314 an HTTP Delete message to the URL for the data channel enabled WHIP/WHEP server instance. The WebRTC server 300 dismantles the WebRTC connection and sends 316 an HTTP Delete response.

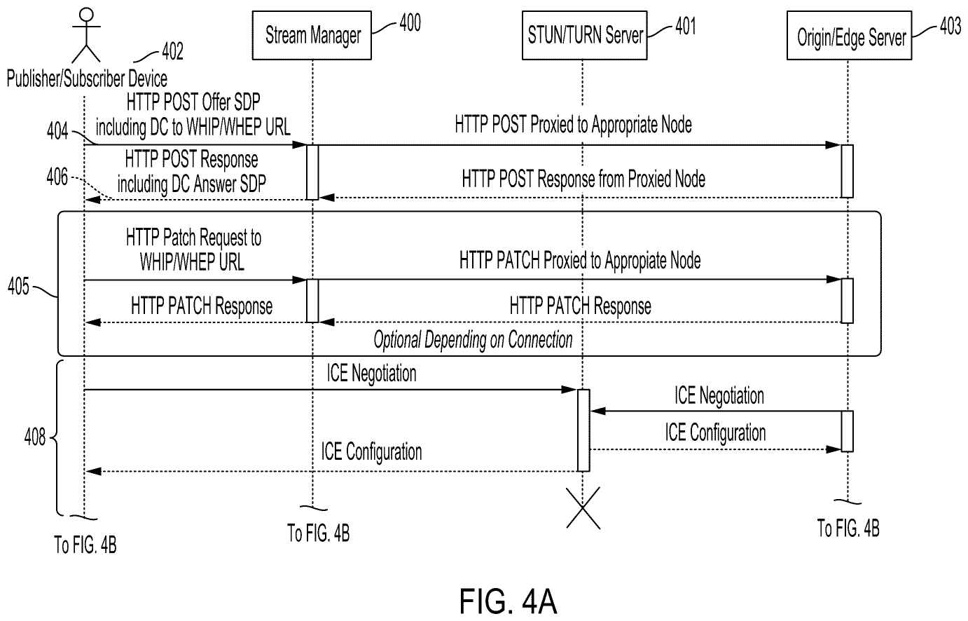

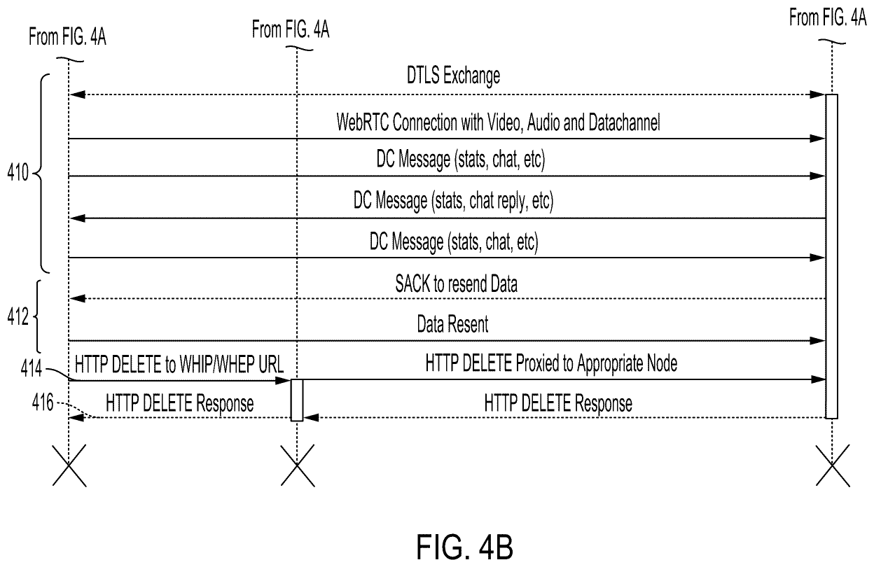

FIGS. 4A and 4B are a sequence diagram describing a session with a Stream Manager cluster. Using a Stream Manager cluster, the publisher device 402 transmits a stream to an origin server 403, which acts as a client recipient. Similarly, an edge server 403 transmits a stream to a subscriber device 402. Data is transmitted between the origin server and the edge server within the Stream Manager cluster using another low latency protocol such as described in the patent documents cited above.

In FIG. 4A, the initial offer message is sent 404 by the publisher or subscriber device 400 to a Stream Manager server 400, which acts as a proxy to redirect the message to the origin or edge server 403 assigned to the stream. In some implementations, the Stream Manager server 400 is a signaling server which manages connecting publisher and subscriber devices to a media server. In some implementations, the Stream Manager server 400 also performs, in addition to signaling server functions, other functions to manage a cluster of servers, such as monitoring, cluster management, stats collection, server assignment, and server startup and spin-down. The answer from the origin or edge server 403 is sent to the Stream Manager server 400, which is proxied in turn to the corresponding publisher device or subscriber device 402, as indicated at 406. In some implementations, the publisher or subscriber device may communicate (405) HTTP Patch requests and responses with the Stream Manager server 400, which in turn proxies such requests and responses between the origin or edge servers.

The response received at 406 also includes information about Interactive Connectivity Establishment (ICE) candidates for the WebRTC connection. Using the provided ICE candidates, a publisher device 402, as indicated at 408, completes the WebRTC connection with the assigned origin server by initiating ICE negotiation and configuration with the STUN/TURN server 401 and the origin server 403. Similarly a subscriber device 402 completes the WebRTC connection with the assigned edge server by initiating ICE negotiation and configuration with the STUN/TURN server 401 and the edge server 403.

In the example of FIG. 4B, after establishment of the data channels on the WebRTC connection, the publisher device 402 can use the Datagram Transport Layer Security (DTLS) exchange of the WebRTC protocol to transmit and receive (410) any data over data channels and transmit any audio or video streams over audio or video channels directly with the assigned origin server 403. Similarly, the subscriber device 402 can use the Datagram Transport Layer Security (DTLS) exchange of the WebRTC protocol to transmit and receive (410) any data over data channels and receive any audio or video streams over audio or video channels directly with the assigned edge server 403.

Similar to FIG. 3, data can be resent as indicated at 412. Also, when the applications on the publisher device 402 or subscriber device 402 and origin server or edge server 403 cease communicating, the device 402 sends 414 an HTTP Delete message to the URL for the data channel enabled WHIP/WHEP server instance of the Stream Manager 400, which coordinates dismantling the WebRTC connection with the server 403 and which sends 416 an HTTP Delete response to the device 402.

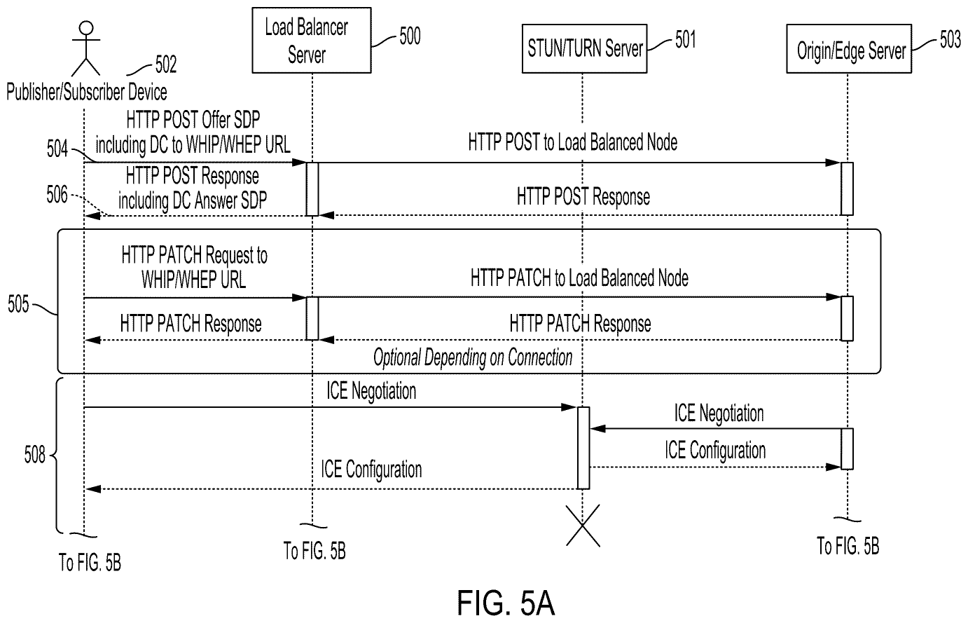

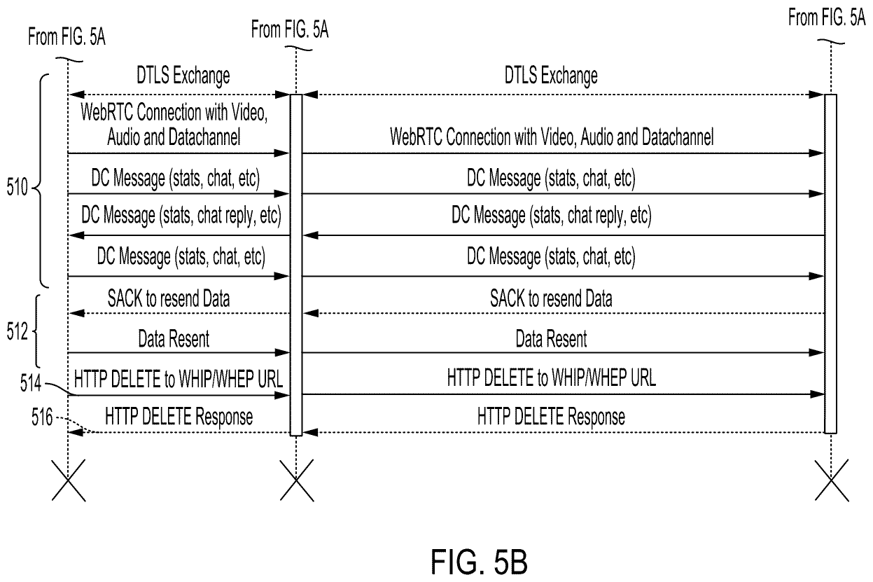

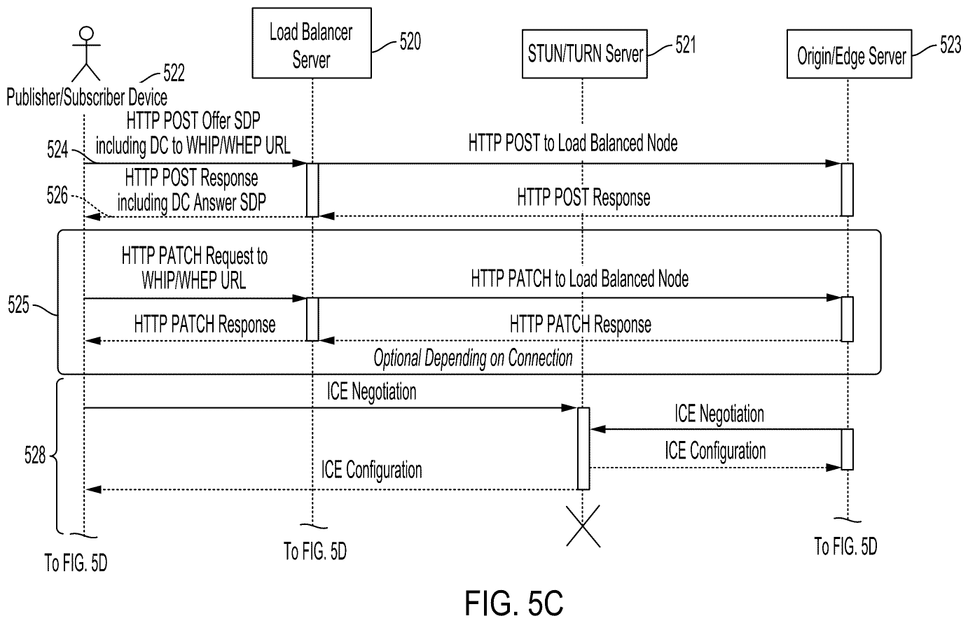

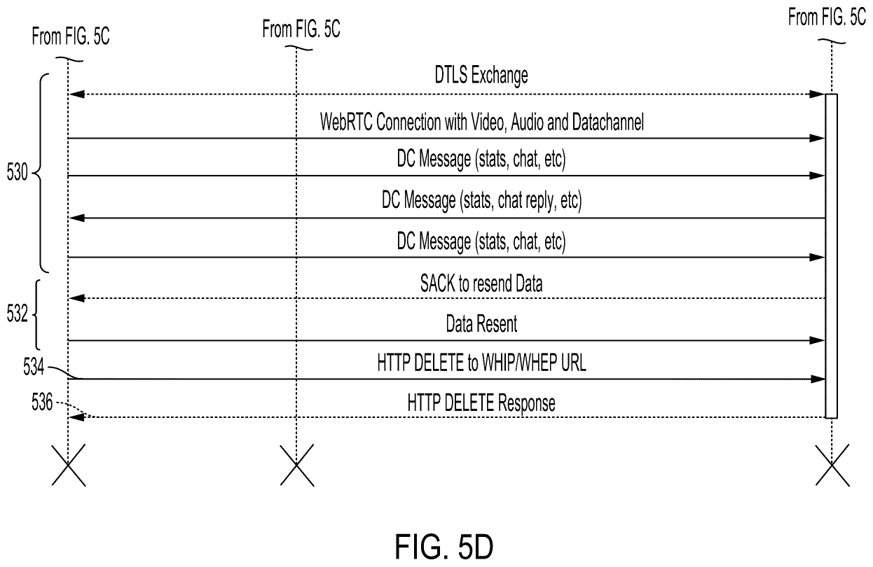

FIGS. 5A and 5B are a sequence diagram describing a session using a load balanced cluster. Using a load balanced cluster, a publisher device 502 transmits a stream to an origin server 503, which acts as a client recipient. Similarly, an edge server 503 transmits a stream to a subscriber device 502. Data is transmitted between the origin server and the edge server within a cluster of servers using another low latency protocol such as described in the patent documents cited above.

In FIG. 5A, the initial offer message is sent 504 by the publisher or subscriber device to a load balancer server 500. For a publisher device, the load balancer server 500 selects an origin server 503 to be assigned to the publisher device based on a load balancing algorithm, and sends a message to the selected origin server. For a subscriber device, the load balancer server 500 selects an edge server 503 to be assigned to the subscriber device based on a load balancing algorithm, and sends a message to the selected edge server assigned to the subscriber device. In some implementations, the load balancer server 500 manages a set of independent servers which are neither origin nor edge devices, in which case the load balancer selects and assigns a server to a publisher device or a subscriber device. In FIG. 5A, the answer from the origin or edge server 503 is sent to the load balancer server 500, which is sent 506 in turn to the corresponding publisher device or subscriber device for further communications. The remaining steps of optional patch requests and responses (505), and ICE configuration and negotiation (508) with the STUN/TURN server 501, are similar to the setup described in FIG. 4A.

In the example of FIG. 5B, after establishment of the data channels on the WebRTC connection, the publisher device 502 can use the Datagram Transport Layer Security (DTLS) exchange of the WebRTC protocol to transmit and receive (510) any data over data channels and transmit any audio or video streams over audio or video channels. Similarly, the subscriber device 502 can use the Datagram Transport Layer Security (DTLS) exchange of the WebRTC protocol to transmit and receive (510) any data over data channels and receive any audio or video streams over audio or video channels.

Similar to FIGS. 3 and 4B, data can be resent as shown at 512. Also, when the applications on the publisher or subscriber device 502 and origin or edge server 503 cease communicating, the device 502 sends 514 an HTTP Delete message to the URL for the data channel enabled WHIP/WHEP server instance of the load balancer server 500, which coordinates dismantling the WebRTC connection with the server 503 and which sends 516 an HTTP Delete response to the device 502. As illustrated in FIG. 5B, such communications 510-516 are proxied through the load balancer server 500 to the assigned origin or edge server 503.

In FIGS. 5C and 5D, is another example implementation where a load balancer starts the connection, but then the publisher device or subscriber device transitions to using a direct connection to the selected origin server or selected edge servers after the setup. In this implementation, the setup process of FIG. 5C is similar to that shown in FIG. 5A. The initial offer message is sent 524 by the publisher or subscriber device to a load balancer server 520. The load balancer server 520 selects an origin or edge server 523 sends a message to the selected origin or edge server. The answer from the origin or edge server 523 is sent to the load balancer server 520, which is sent 526 in turn to the corresponding publisher or subscriber device. The remaining steps of optional patch requests and responses (525), and ICE configuration and negotiation (528) with the STUN/TURN server 521 are similar to the setup described in FIG. 5A.

In the example of FIG. 5D, after establishment of the data channels on the WebRTC connection, the publisher device 522 can use the Datagram Transport Layer Security (DTLS) exchange of the WebRTC protocol to transmit and receive (530) any data over data channels and transmit any audio or video streams over audio or video channels directly with the origin server 523. Similarly, the subscriber device 522 can use the Datagram Transport Layer Security (DTLS) exchange of the WebRTC protocol to transmit and receive (530) any data over data channels and receive any audio or video streams over audio or video channels directly with the edge server 523.

Similar to FIGS. 3 and 4B, data can be resent as shown at 532. Also, when the applications on the publisher or subscriber device 522 and origin or edge server 503 cease communicating, the device 522 sends 534 an HTTP Delete message to the URL for the data channel enabled WHIP/WHEP server instance of the load balancer server 500, which coordinates dismantling the WebRTC connection with the server 523 and which sends 536 an HTTP Delete response to the device 522.

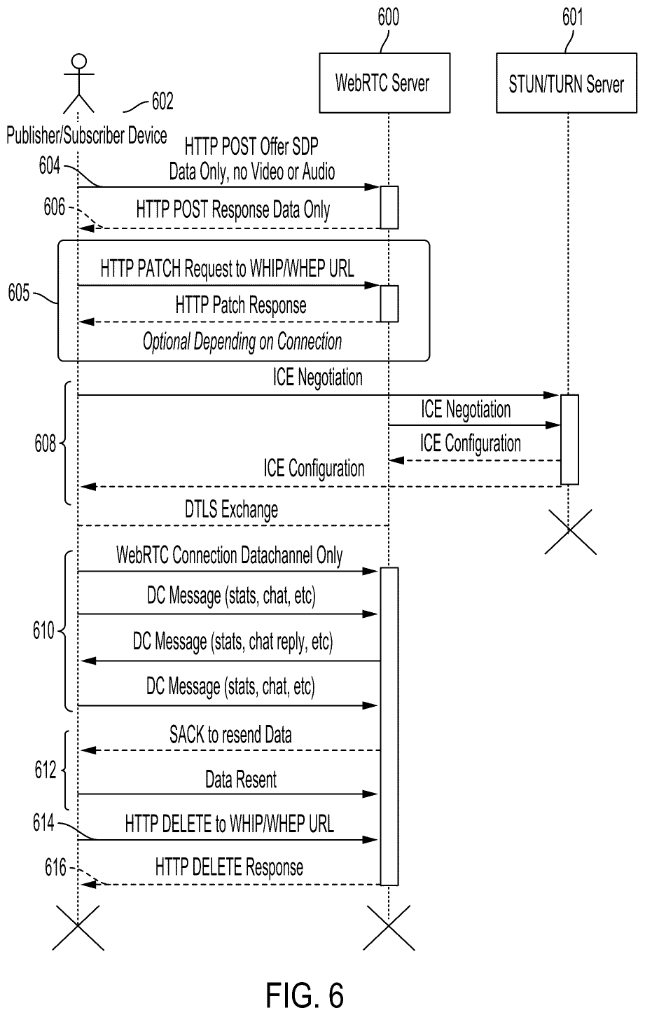

FIG. 6 is a sequence diagram describing a session using a data channel without streaming media. In this implementation, the session description protocol (SDP) offer and answer do not specify any audio or video channel. This implementation can be applied to any of the configurations described in FIGS. 2 through 5A-5D.

An application on the publisher device 602 invokes a call to the data channel enabled WHIP/WHEP client layer, indicating one or more data channels, and no video or audio channels. The data channel enabled WHIP/WHEP client layer sends (604) the Post message to the WebRTC server 600. This message includes an offer with a session description in the SDP format indicating the one or more data channels (DC) to be created. The data channel enabled WHIP/WHEP server instance returns (606) the answer, which includes information about the data channel (DC) and the WebRTC connection. The optional HTTP Patch requests and responses (605) and ICE negotiation and configuration 608 with the STUN/TURN server 601 is similar to FIG. 3. After establishment of the data channels on the WebRTC connection, the publisher device 602 can use the Datagram Transport Layer Security (DTLS) exchange of the WebRTC protocol to transmit and receive (610) any data over data channels. As in the other implementations, data can be resent (612). Also, when the applications cease communicating, the HTTP Delete and response messages 614 and 616 can be used to dismantle the WebRTC connection.

A WebRTC connection can be established with only one, or more than one, data channel without any audio or video channel. Such a data channel is bidirectional, low latency, and real-time, allowing a variety of communication applications which exchange data, such as text-based chat, betting data for sports microbetting applications, telemetry data from vehicles or aircraft, among other things.

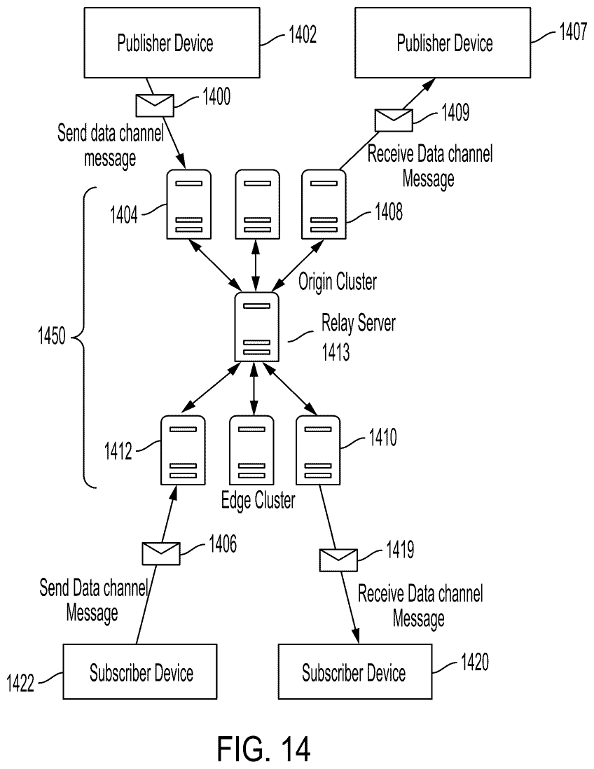

FIG. 14 is a block diagram describing how such a system propagates data channel messages in a clustered system, such as in FIGS. 4A and 4B, FIGS. 5A and 5B, and FIGS. 5C and 5D. Specifically, this block diagram depicts how the system sends messages among all connected users. Notably, a publisher device 1402 or 1407 and a subscriber device 1422 or 1420 can bidirectionally exchange data over an established data channel through a cluster 1450. Data 1400 can be sent from the publisher device 1402 to its origin server 1404 in the cluster, through the cluster 1450, optionally through one or more relay servers 1413, to the edge server 1410 associated with a subscriber device 1420, which ultimately send data 1419 to the subscriber device 1420. Similarly, data can be sent from a subscriber device 1422 to its edge server 1412 in the cluster, through the cluster 1450, optionally through one or more relay servers 1413, to the origin server 1408 associated with the publisher device 1407, which ultimately sends the data 1409 to the publisher device 1407. Communication can be bidirectional, i.e., subscriber device 1420 can also send data to publisher device 1402, and publisher device 1407 and send data to subscriber device 1422. In some implementations, in addition, the publisher device may send live streaming media data, such as audio or video or both, to the subscriber device. In some implementations, the data channels can direct data to and from yet other devices, whether devices that are part of the cluster or external to the cluster.

Note that in some implementations, the cluster of nodes can distribute data channel messages throughout the cluster to keep nodes in synchronization or with consistent data and state or both. As another example, a synced object can be shared over a data channel to keep peers in synchronization or with consistent data and state or both. In some implementations, the cluster of nodes can distribute data channel messages throughout the cluster. Data is pushed throughout the cluster via messaging queues which is then distributed to other clients implementing the data channel enabled WHEP/WHIP protocol who need to receive the data.

### Data Types

A wide variety of data types can be transmitted using such a data channel. The following is a non-limiting set of examples.

Key-Length-Value (KLV) data includes any data in the format of a key field, identifying the kind of data being transmitted, a length field, indicating the size of the data being transmitted, and a value field, providing the data being transmitted. For video systems supporting SMPTE standards, KLV data is defined by an encoding standard and is used to embed information in video feeds. The standard is defined in SMPTE 336M-2007, and the KLV data has the following format: Key Field: 1 to 16 bytes; Length Field: 1, 2 or 4 bytes; Value Field: data being transmitted.

JavaScript Object Notation (JSON) is an open format used for data exchange. It has the following format: Key Field: describes the data being transmitted Value: data being transmitted.

Remote procedure call (RPC) data also can be used. There are many standardized formats for RPCs. For example, in gRPC, RPC messages consist of a request message and a response message. The request message typically includes a method name, input parameters, and optional metadata, while the response message includes a return value and optional metadata. In Apache Thrift and CORBA, the RPC message typically includes information about the remote procedure to be called, any input parameters required for the procedure, and any output or return values that are returned by the procedure.

SCTE-35 is standard describing the inline insertion of cue markers in video streams. SCTE-35 data includes: Program Splice Information: data about timing such as the next splice event, the duration of the splice seven and the type of splice even (start, end, overlap); Component Splice Information: data about what is being spliced or replaced such as information about which audio and video streams will be spliced; and Segmentation Description Information: metadata about the segment such as program id, segment id and duration of the segment.

Binary, freeform, custom, or semi-structured data also can be used on a WebRTC data channel. With this kind of data, a developer can define a data structure to match requirements of a given application or use case. Developers can design the data structure as they see fit.

### Use Cases

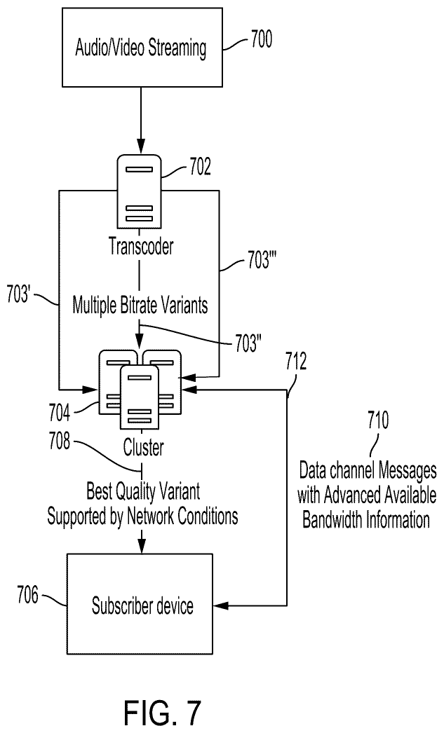

The following description and related drawings (FIGS. 7 through 13, and FIGS. 15A and 15B) depict different use cases for a system with a data channel enabled WHIP/WHEP layer, such as text messaging, file transfer, sports betting data, real-time gaming, and streaming stats, including data channel-only applications. Because the data channel is bidirectional, low latency, and real-time, it allows a variety of communication applications which exchange data, such as text-based chat, betting data for sports microbetting applications, telemetry data from vehicles or aircraft, spacecraft, watercraft, robots, including autonomous vehicles, and yet other applications. These use cases demonstrate the versatility and usefulness of the sole or added data channel support. In the following drawings and description, the setup of the data channels over a WebRTC connection, and any associated audio or video streaming channels, occurs using the setup processes as described above in connection with FIGS. 2 through 6.

### Adaptive Bit Rate, Adaptive Compression, and Adaptive Transcoding

As shown in FIG. 7, the information provided by the data channel can be used to select a transcoder that achieves a desired bit rate or other characteristics for the encoded data, such as a data format that can be processed by a downstream device. Using a data channel in this way allows the system to provide more detailed information about stream conditions than is sent in RTCP messages for receiver estimated maximum bitrate (REMB) communications (see H. Alvestrand, Ed., “RTCP message for Receiver Estimated Maximum Bitrate,” version 3.0, dated Oct. 13, 2013, hereby incorporated by reference).

Thus, in FIG. 7, an audio and video streaming system 700 provides audio and video streams to a transcoder 702. The transcoder 702 generates multiple streams 703′, 703″, and 703′″, representing multiple bitrate variants of the received audio and video streams, which in turn are provided to the cluster 704. A subscriber device 706 establishes a bidirectional data channel 710 over which it can transmit data channel messages 710 which include advanced available bandwidth information. This information can be used by the edge device in the cluster 704, to which the subscriber device is assigned, to select from among the bitrate variants 703′, 703″, and 703′″ for transmission to the subscriber device. The edge device can in turn send various metadata to the subscriber device 706 over the data channel 712.

In some implementations, the data channel can be used to gather and store transmission, bandwidth utilizations, messages, and other data such as statistics to improve stream quality and operations for scaling. In some implementations, various artificial intelligence and machine learning algorithms can be applied to the stored data to in turn automatically adjust cluster and stream settings in real time.

### Ad Insertion

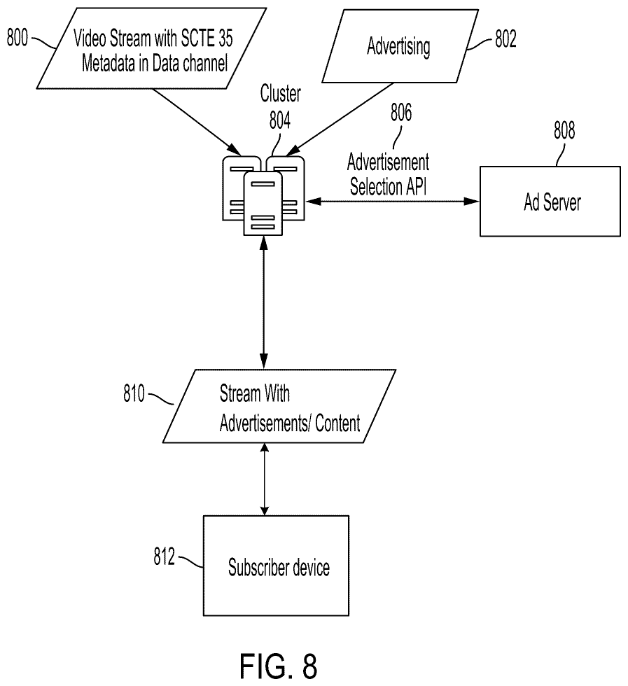

In some implementations, such as shown in FIG. 8, advertisement or other data insertion can be achieved using the SCTE-35 standard. The SCTE-35 standard is a joint ANSI/Society of Cable and Telecommunications Engineers core signaling standard for advertising and distribution control of content for content providers and content distributors. The SCTE-35 signals can be used to identify advertising breaks, advertising content, and programming content, i.e., specific programs, or chapters within a program, or both. The SCTE-35 signals can specify advertisement placement opportunities by indicating the presentation time where digital content can be inserted and for what duration along with other information.

In some implementations, the SCTE-35 data can be included in any video content as in-band data. The SCTE-35 signals can be inserted by an encoder into the video content as in-band data. For example, such SCTE-35 signals can be included as in-band data when using real-time messaging protocol (RTMP). In another example, such SCTE-35 signals can be included as part of the manifest when using the HTTP live streaming (HLS) protocol.

In some implementations, the SCTE-35 data is provided off-band. Using that approach, a server in the live streaming cluster processes the SCTE-35 data before receiving the video to which the SCTE-35 data refers (typically by reference to timestamps). In this way, the digital content is pre-fetched ahead of time by the server, thus guaranteeing higher chances of displaying the expected digital content to each client.

In some implementations, the SCTE-35 data or similar data can be used in the context of a system such as described in U.S. patent application Ser. No. 17/713,401, filed Apr. 5, 2022, entitled “SERVER-SIDE DIGITAL CONTENT INSERTION IN AUDIOVISUAL STREAMS BROADCASTED THROUGH AN INTERACTIVE LIVE STREAMING NETWORK”, hereby incorporated by reference.

In FIG. 8, the WebRTC connection with a publisher device (not shown) can include one or more audio and video streaming channels and a data channel with an origin device in a cluster 804. As indicated at 800, the SCTE-35 metadata can be transmitted using the data channel, while the video (and audio) are streamed using their respective channel(s). A stream of advertising data or other information 802 also can be provided to the cluster 804 over a data channel (if not streaming data) or over one or more audio or video channels from the same or another publisher device (not shown). A server within the cluster 804 can use the SCTE-35 data and/or the advertising data 800 to access an ad server 808 using an API 806 to retrieve content as specified by the SCTE-35 data. A server within the cluster 804 combines the content specified by the SCTE-35 data or by other data with the video stream 800, to create a stream 810 for transmission to a subscriber device 812 over audio and video channels on a WebRTC connection with the subscriber device 812. A data channel on that WebRTC connection can be used to transmit non-streaming data. The data channel on the WebRTC connection between the subscriber device 812 and edge device in the cluster 804 can provide information from the subscriber device 812 which also may be used in the selection of content from the ad server 808. The data channel with the subscriber device also can provide feedback from the subscriber device related to the advertisement or other content.

### Chat

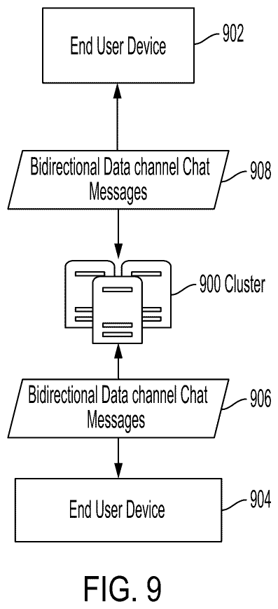

In some implementations, such as shown in FIG. 9, an application which provides a chat functionality can be executing on two distinct end user devices 902 and 904. In such implementations, each end user device 902 and 904 can be set up as both a subscriber device and a publisher device connected to a cluster 900 of servers. Using the data channel enabled WHIP/WHEP protocols, audio and video channels are configured by the applications for transferring video or audio data, and a bidirectional data channel can be used to transmit other information 906, 908 such as text, still images, or other data. The audio and video channels and bidirectional channel can be established on a single WebRTC connection.

Similar to a chat application, other kinds of communication applications can be implemented, such as a whiteboard application, or a collaborative application, such as a collaborative editing tool or video conferencing.

### File Transfer

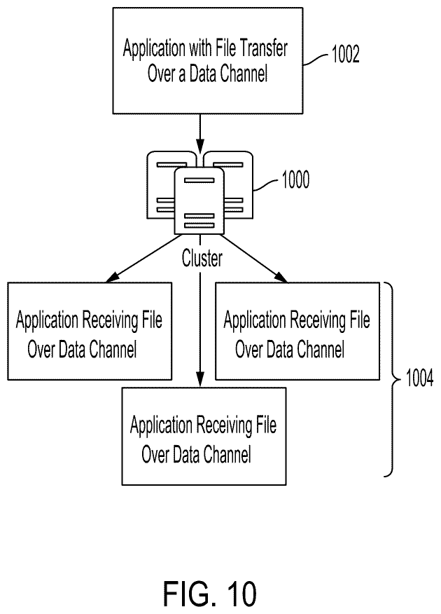

In some implementations, such as shown in FIG. 10, an application 1002 can include a file transfer functionality. In this example implementation, an application 1002 on one end user device transmits a data file over an established data channel to a cluster 1000 of servers. Data over established data channels is then broadcast by a server in the cluster 1000 to other end user devices 1004.

### Screen Sharing

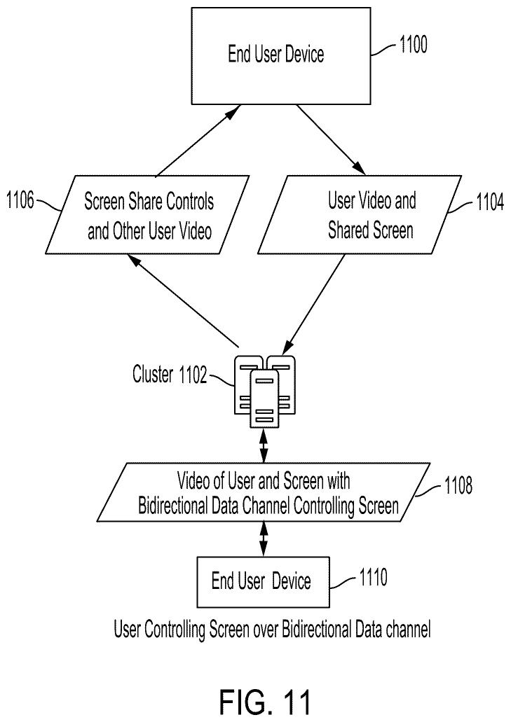

In some implementations, such as shown in FIG. 11, applications on end user devices 1100 and 1110 connected by a cluster 1102 can include screen sharing functionality. In such applications, an end user device 1100 shares image data 1104 from a screen over a video channel as a publisher device that provides the image data 1104 to the cluster 1102. The end user device 1100 also may provide video of the user in another video channel on that connection. Control information from one or more users to control what is shown on the shared screen can be received by the end user device 1100 over a bidirectional data channel, as indicated at 1106. User video from the other end user device 1110 also can be transmitted in parallel over one or more media channels, as indicated at 1108, with the end user device 1110 configured as a publisher device. The end user devices 1100 and 1110 can be configured as subscriber devices to receive the shared screen video feed. End user devices of yet other users can be configured like the end user device 1110.

### Metadata Transmission to Client Devices, Such as Sports Metadata

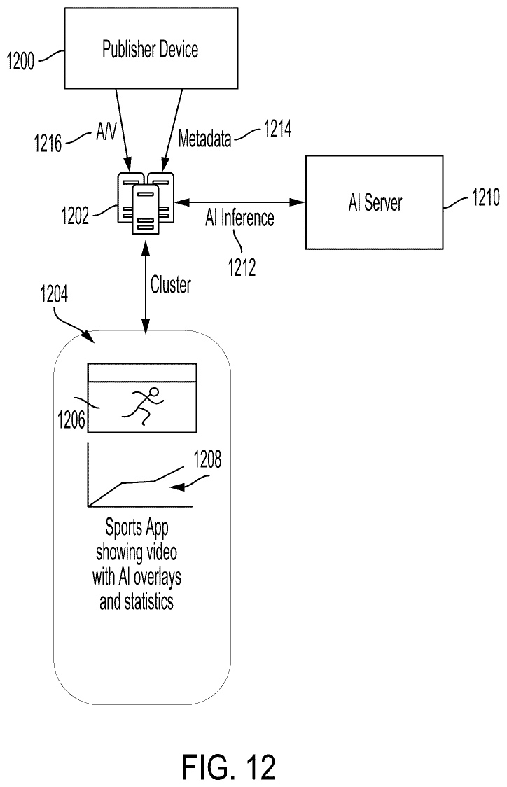

In some implementations, such as shown in FIG. 12, one or more applications executing on one or more publisher devices 1200 may generate metadata 1214 related to a sporting event or other event. In some applications there can be server publisher devices 1200. Video and audio from the sporting event (1216) may be available through the application as shown in FIG. 12, or through another system, or through other live media channels within the system. The metadata can be transmitted over the data channel established using the data channel enabled WHIP/WHEP protocol between the application on the publishing device and a server computer in a cluster 1202, as described above. The data received by the cluster 1202 can be shared with a computational model, such as a machine learning model, artificial intelligence model, or other software that generates additional metadata. The cluster can make AI inference calls 1212 to an AI server 1210 implementing the computation model to request and receive such additional metadata. The metadata 1214 and additional metadata generated by the AI server 1210 can be used by the cluster 1306, or can be transmitted over established data channels with subscriber devices 1204. The received data can be displayed in a variety of ways in applications on subscriber devices, such as by displaying overlays 1208 with real-time information synchronized with displayed video and audio data 1206. Interactive and other data from the subscriber devices 1204 also can be communicated to the cluster 1202 and used with the AI server 1210.

Data Transmission from Client Devices, Such as Sports Betting

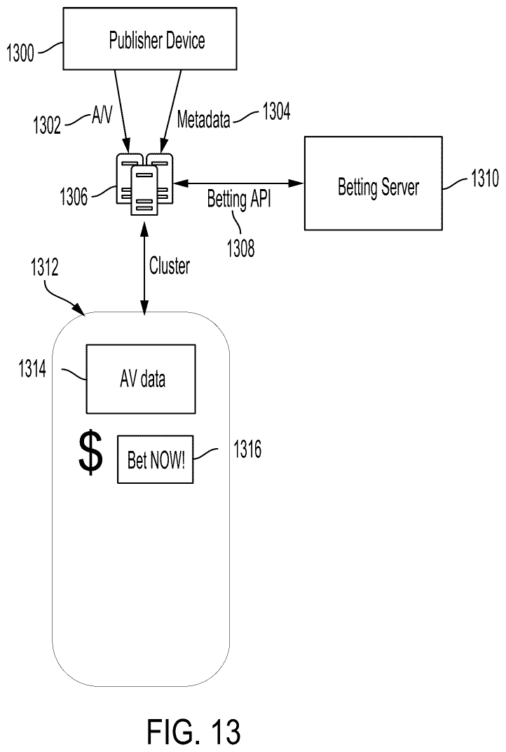

In some implementations, such as shown in FIG. 13, subscriber devices also can provide information responsive to the live media and associated metadata that they have received. The provided information also can be sent over the established data channels. An example use is sports betting where the incoming metadata may include an opportunity to place a wager, and the input from the end user application can be acceptance of that wager.

For example, as shown in FIG. 13, one or more applications executing on one or more publisher device 1300, and typically from multiple separate publisher devices 1300, may generate metadata 1304 related to an event. Video and audio from the event (1302) may be available through the application as shown in FIG. 13, or through another system, or through other live media channels within the system. The metadata 1304 can be transmitted over the data channel established using the data channel enabled WHIP/WHEP protocol between the application on the publishing device and a server computer in a cluster 1306, as described above. The data received by the cluster 1306 can be used, through a betting API 1308, to access a betting server 1310 which receives and stores, and/or provides, additional metadata. The metadata 1304 and additional metadata generated by the betting server 1310 can be transmitted over the established data channels with subscriber devices 1312. The received data can be displayed in a variety of ways in applications on subscriber devices, such as by displaying overlays 1316 with real-time information synchronized with displayed video and audio data 1314. User interaction, such as the placement of a bet, can be communicated over the established data channel to the cluster 1306 and stored in the betting server 1310.

### Digital Rights Management

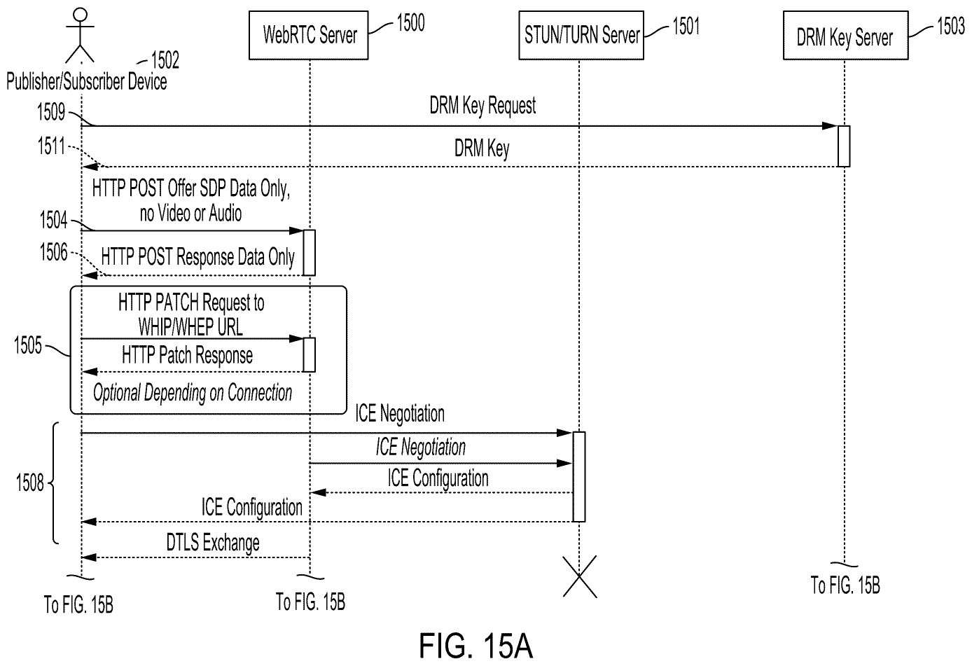

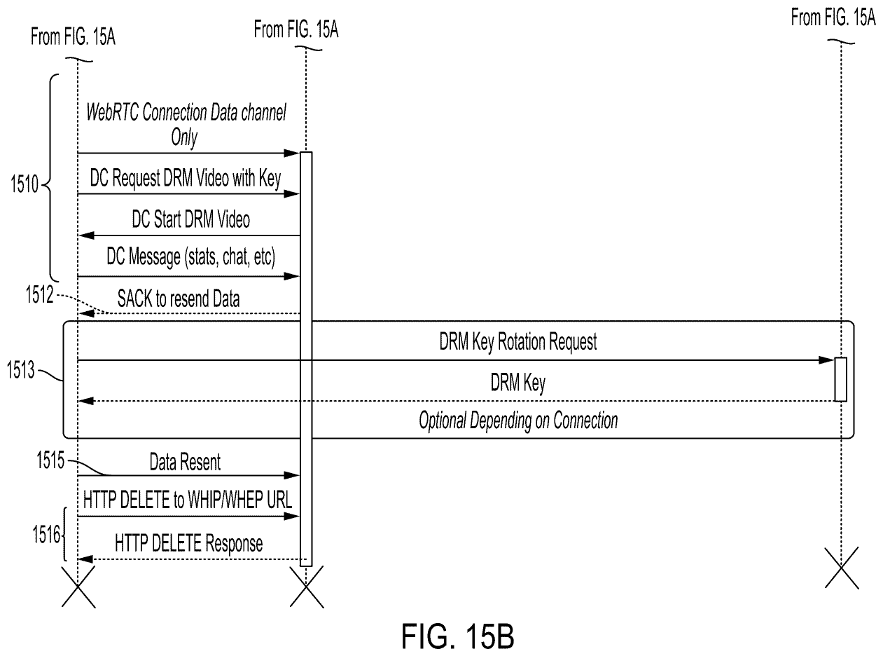

In some implementations, such as shown in FIGS. 15A and 15B, digital rights management (DRM) technology can be supported using data channel enabled WHIP/WHEP protocols. FIGS. 15A and 15B are a sequence diagram describing a session using a data channel to communicate DRM information. Specifically, this sequence diagram illustrates how DRM can be applied using the data channel. An end user device 1502, such as a publisher device or subscriber device, can request 1509 DRM data, such as a key, from a DRM key server 1503. After receiving the DRM key, as indicated at 1511, the end user device 1502 can use this information to transmit data over a data channel in a manner similar to the data channel usage described above in connection with FIGS. 2 through 6. In the example in FIGS. 15A and 15B, only a data channel is created.

An application on the publisher device 1502 invokes a call to the data channel enabled WHIP/WHEP client layer, indicating one or more data channels, and no video or audio channels. The data channel enabled WHIP/WHEP client layer sends (1504) the Post message to the WebRTC server 1500. This message includes an offer with a session description in the SDP format indicating the one or more data channels (DC) to be created. The data channel enabled WHIP/WHEP server instance returns (1506) the answer, which includes information about the data channel (DC) and the WebRTC connection. The optional HTTP Patch requests and responses (1505) and ICE negotiation and configuration 1508 with the STUN/TURN server 1501 is similar to FIG. 6.

After establishment of the data channels on the WebRTC connection, the publisher device 602 can use the Datagram Transport Layer Security (DTLS) exchange of the WebRTC protocol to transmit and receive (1510, FIG. 15B) any data over data channels. These communications can be used to transmit a request message for protected video including the DRM key, and a return message indicating the start of the DRM protected content. As in the other implementations, data can be re-sent (1512). Also, when the applications cease communicating, the HTTP Delete and response messages 1515 and 1516 can be used to dismantle the WebRTC connection. In some implementations, a DRM key is rotated over time, and additional requests 1513 and responses with the DRM server can be performed.

### Remote Procedure Calls (RPC), Compression, Encryption, and Other Functionality

In some implementations, the data channel can be used to transmit remote procedure call (RPC) commands, data, and configuration data. This implementation allows RPC execution across web browsers on client devices. Because a data channel is bidirectional, the data channel can carry both request messages and any response messages.

In some implementations, information sent over the data channel can be compressed. In such implementations, the sending application can implement a kind of compression that is suitable for the information being transmitted. The receiving application can implement the corresponding decompression.

In some implementations, information sent over the data channel can be encrypted. In such implementations, the sending application can implement a kind of encryption that is suitable for the information being transmitted. The receiving application can implement the corresponding decryption.

In some implementations, a real-time streaming protocol, such as RTMP, RTSP, SRT, SIZ, MPEG-TS, MoQ (Media over QUIC) and others may include metadata. A recipient device of such a stream can extract metadata from the streaming protocol and convert it to data transmitted on a separate data channel. Another device can receive metadata and convert the metadata into metadata within the real-time streaming protocol.

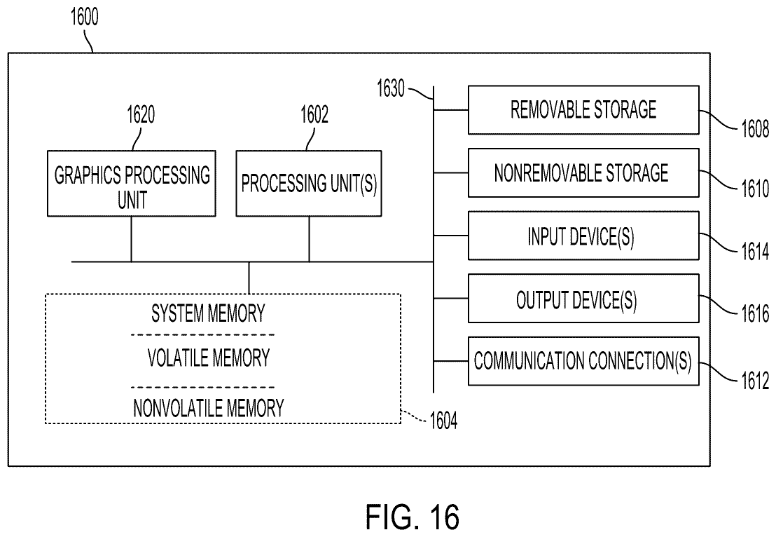

Having now described several example implementations, FIG. 16 illustrates an example of a general-purpose computing device with which can be used to implement a node, server, or device, such as a user's device, client device, publisher device, subscriber device, edge server or edge node, relay server or relay node, origin server or origin node, Stream Manager, media server, transcoder, application server, content server, or other computer system as described here, used in connection with providing a cluster of computers. This is only one example of a computer and is not intended to suggest any limitation as to the scope of use or functionality of such a computer. The system described above can be implemented in one or more computer programs executed on one or more such computers as shown in FIG. 16.

FIG. 16 is a block diagram of a general-purpose computer which processes computer program code using a processing system. Computer programs on a general-purpose computer typically include an operating system and applications. The operating system is a computer program running on the computer that manages and controls access to various resources of the computer by the applications and by the operating system, including controlling execution and scheduling of computer programs. The various resources typically include memory, storage, communication interfaces, input devices, and output devices. Management of such resources by the operating typically includes processing inputs from those resources.

Examples of such general-purpose computers include, but are not limited to, larger computer systems such as server computers, database computers, desktop computers, laptop, and notebook computers, as well as mobile or handheld computing devices, such as a tablet computer, handheld computer, smart phone, media player, personal data assistant, audio or video recorder, or wearable computing device.

With reference to FIG. 16, an example computer 1600 comprises a processing system including at least one processing unit 1602 and a memory 1604. The computer can have multiple processing units 1602 and multiple devices implementing the memory 1604. A processing unit 1602 can include one or more processing cores (not shown) that operate independently of each other. Additional co-processing units, such as graphics processing unit 1620, also can be present in the computer. The memory 1604 may include volatile devices (such as dynamic random-access memory (DRAM) or other random access memory device), and non-volatile devices (such as a read-only memory, flash memory, and the like) or some combination of the two, and optionally including any memory available in a processing device. Other memory, such as dedicated memory or registers, also can reside in a processing unit. This configuration of memory is illustrated in FIG. 16 by dashed line 1604. The computer 1600 may include additional storage (removable or non-removable) including, but not limited to, magnetically recorded or optically-recorded disks or tape. Such additional storage is illustrated in FIG. 16 by removable storage 1608 and non-removable storage 1610. The various components in FIG. 16 typically are interconnected by an interconnection mechanism, such as one or more buses 1630.

A computer storage medium is any medium in which data can be stored in and retrieved from addressable physical storage locations by the computer. Computer storage media includes volatile and nonvolatile memory devices, and removable and non-removable storage devices. Memory 1604, removable storage 1608 and non-removable storage 1610 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 1600 may also include communications connection(s) 1612 that allow the computer to communicate with other devices over a communication medium. Communication media typically transmit computer program code, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 1612 are devices, such as a network interface or radio transmitter, that interface with the communication media to transmit data over and receive data from signals propagated through communication media.

The communications connections can include one or more radio transmitters for telephonic communications over cellular telephone networks, or a wireless communication interface for wireless connection to a computer network. For example, a cellular connection, a Wi-Fi connection, a Bluetooth connection, and other connections may be present in the computer. Such connections support communication with other devices, such as to support voice or data communications.

The computer 1600 may have various input device(s) 1614 such as various pointer (whether single pointer or multi-pointer) devices, such as a mouse, tablet and pen, touchpad and other touch-based input devices, stylus, image input devices, such as still and motion cameras, audio input devices, such as a microphone. The computer may have various output device(s) 1616 such as a display, speakers, printers, and so on, also may be included. These devices are well known in the art and need not be discussed at length here.

The various storage 1610, communication connections 1612, output devices 1616 and input devices 1614 can be integrated within a housing of the computer or can be connected through various input/output interface devices on the computer, in which case the reference numbers 1610, 1612, 1614 and 1616 can indicate either the interface for connection to a device or the device itself.

An operating system of a computer typically includes computer programs, commonly called drivers, which manage access to the various storage 1610, communication connections 1612, output devices 1616 and input devices 1614. Such access can include managing inputs from and outputs to these devices. In the case of communication connections, the operating system also may include one or more computer programs for implementing communication protocols used to communicate information between computers and devices through the communication connections 1612.

Each component (which also may be called a “module” or “engine” or the like), of a computer system and which operates on one or more computers, can be implemented as computer program code processed by the processing system(s) of one or more computers. Computer program code includes computer-executable instructions or computer-interpreted instructions, such as program modules, which instructions are processed by a processing system of a computer. Such instructions define routines, programs, objects, components, data structures, and so on, that, when processed by a processing system, instruct the processing system to perform operations on data or configure the processor or computer to implement various components or data structures in computer storage. A data structure is defined in a computer program and specifies how data is organized in computer storage, such as in a memory device or a storage device, so that the data can accessed, manipulated, and stored by a processing system of a computer.

It should be understood that the subject matter defined in the appended claims is not necessarily limited to the specific implementations described above. The specific implementations described above are disclosed as examples only.

What is claimed is:

1. A computer system comprising:
a processing system including one or more processing devices and one or more computer storage devices, the processing system processing computer program instructions that configure the processing system to implement:
an application processing data;
a setup protocol client in communication with the application and responsive to the application to request establishment of a real-time streaming connection using a real-time streaming protocol with another device, the request including a request for one or more bidirectional data channels within the real-time streaming connection; and
a real-time streaming client in communication with the application to receive the data from the application and to communicate the data to the other device over the bidirectional data channel of the real-time streaming connection.

2. The computer system of claim 1, wherein the application further processes streaming media data with the data, and wherein the setup protocol client is further responsive to the application to request establishment of one or more streaming media channels on the real-time streaming connection, and wherein the real-time streaming client is further in communication with the application to further receive the streaming media data and the data from the application and transmit the streaming media data over the one or more streaming media channels of the real-time streaming connection to the other device while communicating data to and from the application and the other device over the bidirectional data channel of the real-time streaming connection.

3. The computer system of claim 2, wherein the setup protocol client comprises a WebRTC for HTTP Ingest Protocol (WHIP) client and the real-time streaming client comprises a WebRTC client supporting the WebRTC protocol.

4. The computer system of claim 3, wherein the computer system comprises a WebRTC streaming server housing a WebRTC server instance and a WHIP/WHEP server instance.

5. The computer system of claim 3, wherein the computer system comprises a stream manager for a cluster of server computers comprising a plurality of WebRTC server computers, wherein each WebRTC server computer includes a respective WebRTC server instance, and wherein the stream manager includes a WHIP/WHEP server instance, and is configured to, in response to a request to the WHIP/WHEP server instance, select a WebRTC server computer for supplying the requested WebRTC connection and to communicate with the WebRTC server instance of the selected WebRTC server computer.

6. The computer system of claim 3, wherein the computer system comprises a load balancer for a collection of server computers comprising a plurality of WebRTC server computers, each WebRTC server computer including a respective WebRTC server instance and an associated WHIP/WHEP server instance, and wherein the load balancer is configured to, in response to a request, select a WebRTC server computer for supplying the requested WebRTC connection and to communicate with the WHIP/WHEP server instance of the selected WebRTC server computer, and wherein the WHIP/WHEP server instance of the selected WebRTC server computer is configured to respond to the setup protocol client.

7. The computer system of claim 2, wherein the data on the bidirectional data channel includes metadata to be synchronized with the live real-time streaming media data.

8. The computer system of claim 1, wherein the real-time streaming client further is configured to receive data from the other device over the bidirectional data channel of the real-time streaming connection and to communicate the data to the application.

9. A computer system comprising:
a processing system including one or more processing devices and one or more computer storage devices, the processing system processing computer program instructions that configure the processing system to implement:
an application processing data;
a setup protocol client in communication with the application and responsive to the application to request establishment of a real-time streaming connection using a real-time streaming protocol with another device, the request including data specifying one or more bidirectional data channels with the real-time streaming connection; and
a real-time streaming client in communication with the application to communicate the data received from the other device over the bidirectional data channel of the real-time streaming connection to the application.

10. The computer system of claim 9, wherein the application further processes streaming media data with the data, and wherein the setup protocol client is further responsive to the application to request establishment of one or more streaming media channels on the real-time streaming connection, and wherein the real-time streaming client is further in communication with the application to further receive the streaming media data over the one or more streaming media channels of the real-time streaming connection from the other device, while communicating data to and from the application and the other device over the bidirectional data channel of the real-time streaming connection and communicating the received streaming media data to the application.

11. The computer system of claim 10, wherein the setup protocol client comprises a WebRTC for HTTP Egress Protocol (WHEP) client and the real-time streaming client comprises a WebRTC client supporting the WebRTC protocol.

12. The computer system of claim 11, wherein the computer system comprises a WebRTC streaming server housing a WebRTC server instance and a WHIP/WHEP server instance.

13. The computer system of claim 11, wherein the computer system comprises a stream manager for a plurality of server computers comprising a plurality of WebRTC server computers, each WebRTC server computer including a respective WebRTC server instance, and wherein the stream manager includes a WHIP/WHEP server instance, and wherein the stream manager is configured to, in response to a request, select a WebRTC server computer for supplying the requested WebRTC connection and to communicate with the WebRTC server instance of the selected WebRTC server computer.

14. The computer system of claim 11, wherein the computer system comprises a load balancer for a plurality of server computers including a plurality of WebRTC server computers, each WebRTC server computer including a respective WebRTC server instance and an associated WHIP/WHEP server instance, and wherein the load balancer is configured to, in response to a request, select a WebRTC server computer for supplying the requested WebRTC connection and to communicate with the WHIP/WHEP server instance of the selected WebRTC server computer, and wherein the WHIP/WHEP server instance of the selected WebRTC server computer responds to the setup protocol client.

15. The computer system of claim 10, wherein the data on the bidirectional data channel includes metadata to be synchronized with the live real-time streaming media data.

16. The computer system of claim 9, wherein the real-time streaming client further is configured to receive data from the application and to send data to the other device over the bidirectional data channel of the real-time streaming connection.

17. A computer system comprising:
a processing system including one or more processing devices and one or more computer storage devices, the processing system processing computer program instructions that configure the processing system to implement:
a real-time streaming server instance supporting establishment of a real-time streaming connection with one or more bidirectional data channels, to communicate data over the one or more bidirectional data channels of the real-time streaming connection; and
a setup protocol server instance responsive to requests from other devices to establish a real-time streaming connection with the real-time streaming server instance, the requests including a request for one or more bidirectional data channels within a requested real-time streaming connection, wherein the setup protocol server instance, in response to a request from a device, issues a request to the real-time streaming server instance to establish the requested real-time streaming connection with the requested one or more bidirectional data channels, and responds to the device with connection information for the device to complete the requested real-time streaming connection.

18. The computer system of claim 17, the setup protocol server instance is further responsive to requests to establish one or more streaming media channels on the real-time streaming connection.

19. The computer system of claim 18, wherein the setup protocol server instance comprises a WebRTC for HTTP Ingress or Egress Protocol (WHIP or WHEP) server instance and the real-time streaming server instance comprises a WebRTC server instance supporting the WebRTC protocol.

20. The computer system of claim 18, wherein the data on the bidirectional data channel includes metadata to be synchronized with the live real-time streaming media data.
